(19) United States
(12) Patent Application Publication
(10) Pub. No.: US 2006/0046113 A1
(43) Pub. Date: Mar. 2, 2006

(54) Stacked reactor with microchannels

(75) Inventors: Conghua Wang, Princeton Jct., NJ (US); Joey John Michalchuk, Lambertville, NJ (US)

Correspondence Address: SARNOFF/JACKSON, PATENT DEPARTMENT, SARNOFF CORPORATION, 201 WASHINGTON ROAD CN 5300, PRINCETON, NJ, 08543-5300, US

(73) Assignee: Sarnoff Corporation

(21) Appl. No.: 10/930,923

(22) Filed: Aug. 31, 2004

(51) Int. Cl. H01M 8/06; B01J 8/04

(52) U.S. Cl. 429/20; 429/19; 422/190

(57) ABSTRACT

Provided, among other things, is a stacked reactor comprising: three or more metal layers; two or more catalyst layers sandwiched between the metal layers wherein: (a) catalyst layers comprise catalyst-coated channels formed in a suitable material with depth and width dimensions independently from 10 to 2,000 microns, or (b) surfaces of the metal layers are shaped so as to provide 40% or more surface area than would a flat surface; and sealant enclosing the channel layers in a gas-tight manner (which sealant may be contiguous with the material forming the catalyst-coated channels).

The present invention relates to reactors that allow chemical reactions to take place in very small space while providing effective mass and heat transport. The reactors can, for example, be used for synthesis reactions, such as synthesis of methanol from hydrogen and carbon monoxide, or the synthesis of hydrogen peroxide from hydrogen and oxygen. Other exemplary reactions include the reforming reaction of hydrocarbon to hydrogen and carbon oxides. The reactors can be suitable for use in conjunction with fuel cells. The invention also relates to methods for making such reactors.

Most fuel cells have to use hydrogen gas as the fuel. However, often hydrocarbon fuels, such as natural gas, gasoline, propane or diesel are more readily available. Therefore, fuel cell technology often utilizes reforming reactions to extract hydrogen gas from hydrocarbons.

There are several ways to reform hydrocarbon fuels to hydrogen, such as steam reforming, partial oxidization reforming and auto-thermal reforming process. These reactions are catalytically take place in a reactor (fuel processor) in elevated temperature (normally in the 200-1000° C. range). In general, fuel processors should meet following criteria: 1) low cost, 2) efficient heat exchange, and 3) suitability for mass fabrication. To decrease the expensive due to catalyst loading, workers seek to increase catalytic efficiency. Fuel reforming reactions involve a significant amount of heat transfer, needed for example to effectively deliver heat to reaction sites (e.g., steam reforming), or to transport heat away from reaction sites (e.g., partial oxidization reforming). Cost effective processes to make reactors that effectively use catalyst and have effective heat transfer properties are needed.

### SUMMARY OF THE INVENTION

In one embodiment, the invention relates to a stacked reactor comprising: three or more metal layers; two or more catalyst layers sandwiched between the metal layers wherein:
(a) catalyst layers comprise catalyst-coated channels formed in a suitable material with depth and width dimensions independently from 10 to 2,000 microns, or
(b) surfaces of the metal layers are shaped so as to provide 40% or more surface area than would a flat surface; and
   sealant enclosing the channel layers in a gas-tight manner (which sealant may be contiguous with the material forming the catalyst-coated channels). The stacked reactor can be connected to a fuel cell.

Provided in another embodiment is a method of manufacturing a stacked reactor comprising: providing sheets of shaped material, the shaping having fluid-handling structures adapted to provide channels having depth and width dimensions independently from 10 to 2,000 microns; applying catalyst to the fluid-handling structures; stacking the fluid-handling sheets and alternating metal sheets; and sealing the periphery of the stack by annealing sealant at the periphery to the stacked metal sheets.

Provided in another embodiment is a method of manufacturing a stacked reactor comprising providing sheets of shaped metal, the shaping providing 40% or more surface area than would a flat surface; applying catalyst to shaped surfaces of the metal sheets; stacking the metal sheets; and sealing the periphery of the stack by annealing sealant at the periphery to the stacked metal sheets.

### BRIEF DESCRIPTION OF THE DRAWINGS

FIG. 1A shows a reactor of the invention, in perspective view, with some of the layers separated for illustrative purposes. FIGS. 1B and 1C show illustrative structures for the channel area of the reactor layer

FIG. 2A displays a reactor of the invention with some of the layers separated for illustrative purposes.

FIG. 2B shows a cross-section of a layer of the reactor of FIG. 1A.

FIG. 3A shows another reactor of the invention with some of the layers separated for illustrative purposes.

FIG. 3B shows a cross-section of a forward part of the reactor of FIG. 2A.

FIG. 4 shows another reactor of the invention.

FIGS. 5-7 show further reactors of the invention.

FIGS. 8 and 9 illustrate how the reactors can be used with fuel cells.

FIG. 10 shows another reactor of the invention.

FIG. 11 illustrates how the reactor can be used to support an endothermic and an exothermic reaction.

FIG. 12 shows selected layers of a reactor of the invention.

### DETAILED DESCRIPTION OF THE INVENTION

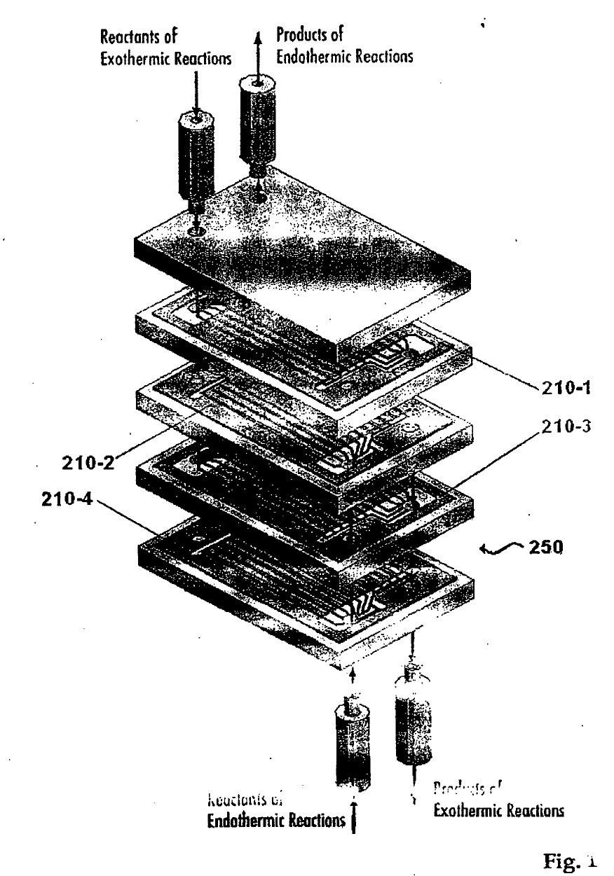

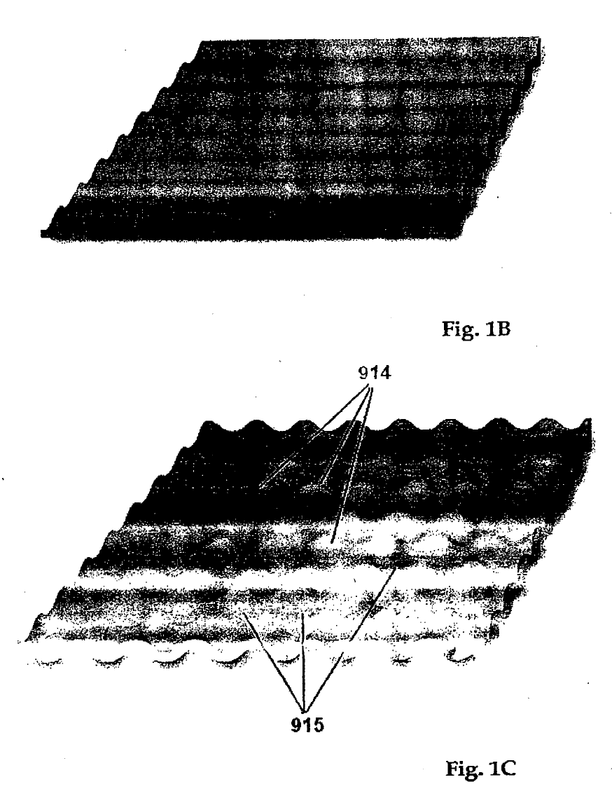

A stacked reactor 250 with alternating feed and drain patterns is illustrated in perspective view FIG. 1. For illustration purposes, the reactor stack is marked for one set of manifolds and fluid-handling layers hosting an endothermic reaction, and the other set an exothermic reaction. The exothermic reaction can provide heat to the adjacent endothermic reaction, such that the endothermic reaction requires no additional external heat or less external heat. The metal plate between adjacent layers is an excellent thermal conductor to transport heat between adjacent layers. In the exemplary use, reactants for exothermic reactions (for example) flow into fluid-handling layers 210-1 and 210-3, and react in an expanded-surface-area region (“ESAR”) to deliver heat and products. The heat is transported through the metal plates to fluid-handling layers 210-2 and 210-4. Meanwhile, reactants for endothermic reactions (for example) flow into fluid-handling layers 210-2 and 210-4, and react in the ESAR while absorbing heat from fluid-handling layers 2101 and 210-3.

Typically in each fluid-handling layer there is an area in which the ESAR is formed, and an area along the perimeter used to bond the reactor stack together and provide reactant/products input/output channels and/or manifolds. Thin coatings on the structure-forming material ESAR (the coatings used for example to modify the surface properties of the area) can be applied by screen-printing, spraying, painting, and the like. Catalyst materials can be applied on the ESAR by physical processes known in the art such as vacuum deposition, or chemical process, such as sol-gel. Catalyst can be applied either before, or after the reactor stack is assembled. Catalyst can be applied onto or in a porous support such as alumina. Where catalyst is applied to a metal surface, typically a relatively thin interface layer is applied to aid in the bonding of catalyst or bonding of the porous support for catalyst.

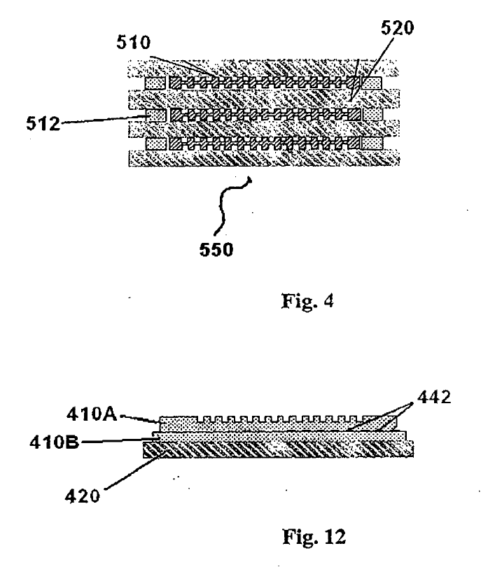

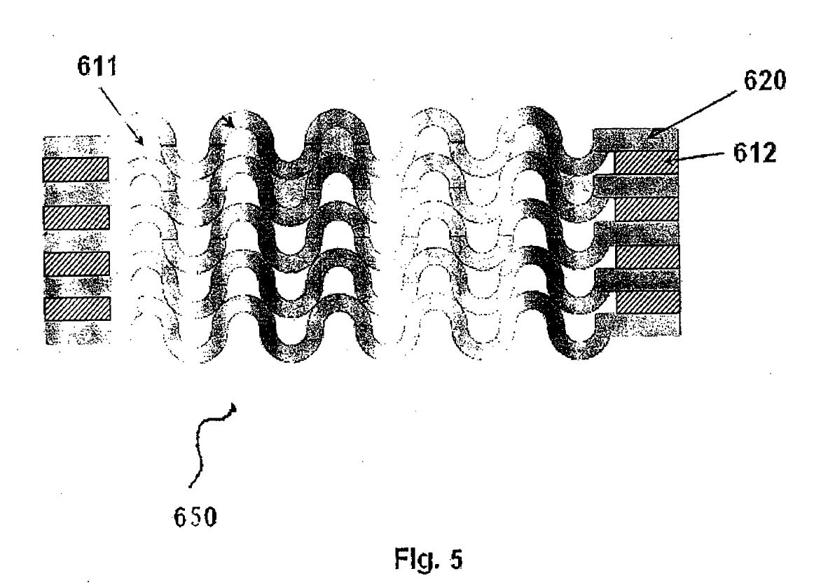

When channels are used to form the ESAR, the channels can be a number of shapes. For example, straight channels would be formed using a corrugated layers as illustrated in FIG. 1B. Stacks of such layers can be used, for example, as metal layers 620 illustrated in FIG. 5. Curved channels (not shown), among other shapes, can be used. More complicated ESAR structures, as can be formed of stacks of the multi-nodal layer illustrated in FIG. 1C, can also be used. If the tops of the nodes 914 are stacked against tops of at adjacent layers, a maze of channels is formed. If the stacking is such that nodes 914 partially insert into valleys 915, then a relatively wide sinusoidal-like channel is formed.

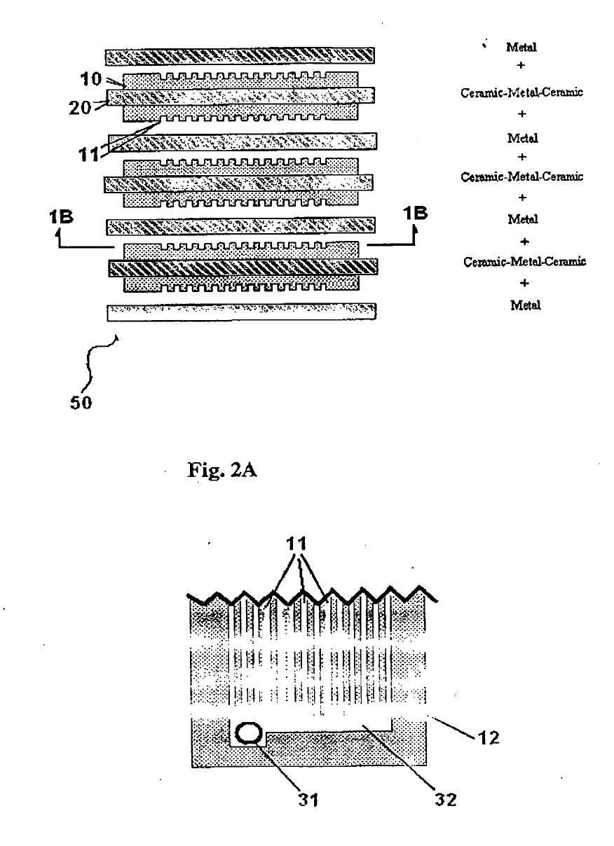

By use of relatively narrow channels or other fluid flow pathways, the interaction of reactant (from a fluid such as a gas or liquid) with catalyst is increased, thereby increasing catalytic efficiency. By keeping the channels straight, or smoothly caved, backpressure is minimized. The depth and/or width of the channels or other fluid flow pathways is, for example, 10 to 2,000 microns. The width is the maximum width across the channels horizontally, using the point-of-view illustrated in FIG. 2A. The depth is the maximum depth of the channels vertically, using the point-of-view illustrated in FIG. 2A. In certain embodiments, the range of the width or the depth is from one of the following lower endpoints (inclusive) to one of the following upper endpoints (inclusive). The lower endpoints are 10, 15, 20, 25, 30, 40, 50, 60, 70, 80, 90, 100, 150, 200, 250, 300, 400, 500, 600, 700, 800, 900, 1,000, 1,100, 1,200, 1,300, 1,400, 1,500, 1,600, 1,700, 1,800 and 1,900 microns (μm). The upper endpoints are 15, 20, 25, 30, 40, 50, 60, 70, 80, 90, 100, 150, 200, 250, 300, 400, 500, 600, 700, 800, 900, 1,000, 1,100, 1,200, 1,300, 1,400, 1,500, 1,600, 1,700, 1,800, 1,900 and 2,000 microns. For example, the width or depth can be from 25 to 200 microns, or from 50 to 200 microns.

The length of the channels or other fluid flow pathways depends on the reactions involved, capacity needs, manufacturing convenience, and the like. Typical lengths can be from 0.5 cm to several meters. For example, the length can be 0.5, 1, 2, 3, 4, 5, 6, 7, 8, 9, 10, 20, 30, 50 cm or more.

FIG. 2A shows a reactor stack 50 of an embodiment of the invention. In this embodiment, reaction channels 11 are formed on the fluid-handling layers 10, and are attached on the metal layer 20. For illustration, certain of the metal layers 20 are shown separated from the fluid-handling layers 10.

FIG. 2B shows a cut-away top view of the channels 11, with a manifold 32 that feeds fluid to or from the channels, and to or from outlet 31. Sealant 12 serves to seal the outer edges of the channels and manifold. Sealant 12 can be, as in this embodiment, contiguous with fluid-handling layer 10. The channels are typically coated with catalyst. (By “coating” it is meant any manner that retains the catalyst in the channels while allowing fluid flow through the channels.)

The channels or other fluid flow pathways can be formed by embossing, stamping, rolling, and the likes. The embossing (or other forming process) of the fluid-handling layers 10 could traverse the thickness of the fluid-handling layers, forming channels that, if applied to this embodiment, would contact the metal layers 20 on two sides. The illustrated embodiment in FIG. 2A uses partial thickness channels.

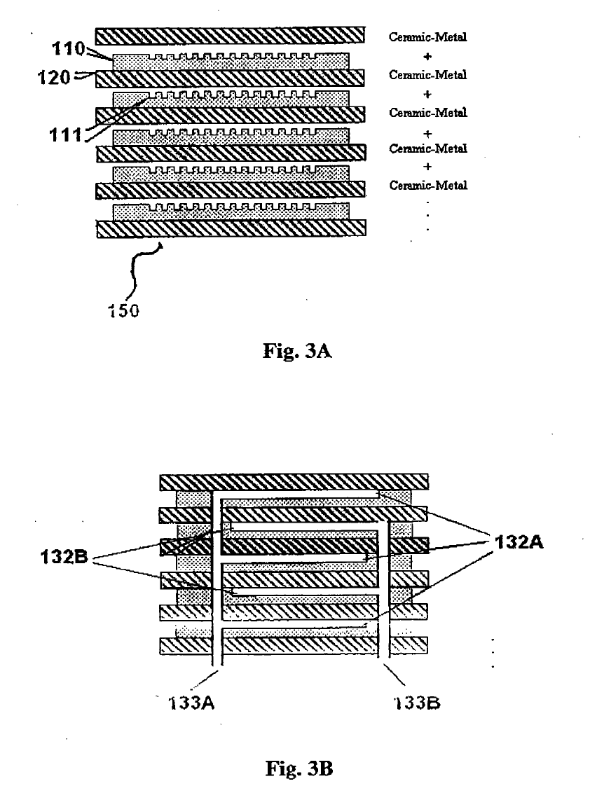

FIG. 3A shows a reactor stack 150 of an embodiment of the invention. The reactor stack has metal layers 120 and fluid-handling layers 110 that form channels 111. Reactor stack 150 can have alternating fluid-handling layers 110 fed (or drained) by conduit 133A and manifolds 132A, as shown in FIG. 313. The remaining fluid-handling layers 110 can be feed by conduit 133B and manifolds 132B. Manifolds at the other ends of the channels can feed or drain as required

The thickness of the material used to form fluid-handling layers (in certain embodiments) is, for example, 10 to 2,000 microns. In certain embodiments, the range of the thickness is from one of the following lower endpoints (inclusive) to one of the following upper endpoints (inclusive). The lower endpoints are 10, 15, 20, 25, 30, 40, 50, 60, 70, 80, 90, 100, 150, 200, 250, 300, 400, 500, 600, 700, 800, 900, 1,000, 1,100, 1,200, 1,300, 1,400, 1,500, 1,600, 1,700, 1,800 and 1,900 microns (μm). The upper endpoints are 15, 20, 25, 30, 40, 50, 60, 70, 80, 90, 100, 150, 200, 250, 300, 400, 500, 600, 700, 800, 900, 1,000, 1,100, 1,200, 1,300, 1,400, 1,500, 1,600, 1,700, 1,800, 1,900 and 2,000 microns. For example, the thickness can be from 100 to 400 microns.

The fluid-handling layers can have structures such as channels formed on both sides, as illustrated in FIG. 4. Reactor 550 has fluid-handling layers 510, which are embossed or otherwise shaped on both sides. The layers are sealed with sealant 512.

As illustrated by the layer shown in FIG. 1B, the ESAR can be a maze of channels, or, as illustrated by the layer shown in FIG. 1C, a undulating structure. A sinusoidal-like pathway or mix of sinusoidal-like pathways can act to induce further contact between fluid and the catalyst on the internal surfaces of the ESAR. It will be recognized that in some embodiments the width and depth of the fluid flow patterns is a somewhat more complex concept. The width and depths are taken from the largest non-expanding and non-contracting tube of round or elliptical cross-section that can in concept be wound from one side of a fluid-handling layer to its opposite side.

By “maze” of channels is meant a structure that (i) provides 40% or more surface area than would provided by hypothetical flat surfaces sandwiching the ESAR region of the fluid handling layer and (ii) provides that the majority of fluid flowing through the fluid handling layer must take a nonlinear or non-smoothly curving path. In certain embodiments, the internal surfaces of the ESAR provide 40% or more, or 45% or more, or 50% or more, or 60% or more, or 100% or more, or 200% or more, or 400% or more, or 1000% or more, surface area than would provided by hypothetical flat surfaces sandwiching the ESAR region of the fluid handling layer.

Where the ESAR is formed by shaped metal layers coated with ceramic interface, the depth is the average separation from ceramic interface surface to ceramic interface surface, and width is not a descriptive parameter.

In certain embodiments, enhanced contact between a fluid in the reactor and the sides of the channels are obtained, for example, (i) with smaller channels having the depths and widths recited above or (ii) by use of a sinusoidal-like flow pathway.

Useful materials for forming channels (and manifolds and seals) include, for example, rubber, plastic, ceramic (including glass), and the like. The material can favorably have a coefficient of expansion similar to that of the metal layers. One useful such material is the ceramic green tape available for tape cast processes. The channels can be formed by embossing, stamping and rolling processes, and the like. The green tape can be laminated (such as after channel forming) to the metal plates using Low-Temperature Co-fired Ceramic-on-Metal technology (LTCC-M), such as described in U.S. Pat. No. 5,581,876, U.S. Pat. No. 5,725,808, U.S. Pat. No. 5,747,931 or U.S. Pat. No. 6,140,795.

It should be recognized that by forming the fluid-handling layers of sub-layers and annealing the sub-layers into a fluid-handling layer, more complex structures for the ESAR can be obtained. Such more complicated structures can be used, for example, to improve the flow field.

In certain embodiments the fluid accessible regions of the ESARs can have good thermal connection with one or both of the sandwiching metal layers. For example, the metal layers may be insulated from these fluid accessible regions by less thermally conductive material that is, for example, 10 microns or less thick, 5 microns or less thick, 4 microns or less thick, 3 microns or less thick or 2 microns or less thick. Porous support for catalyst is not included in the measurement of such thickness.

One process for assembling a reactor of the invention is:
1) Prepare metal plates and the material (e.g. ceramic green tape) for forming fluid-handling layers, such as by tape casting, extrusion, or rolling.
2) Punch the material for forming fluid-handling layers to a desired size with designated holes for fluid routes.
3) Laminate the material for forming fluid-handling layers onto the metal plates.
4) Form micro-channels on the material.
5) Stack and laminate several material-metal layers to build the multi-layer structure.
6) Fire the structure at high temperature to make the stacked reactor.
7) Either before step 5 or after step 6, apply catalyst to the micro-channels.

In one embodiment illustrated in FIG. 5, the channels 611 can be formed by shaping the metal layer 620 of the reactor 650. In the illustrated embodiment, the metal layer 620 is embossed or otherwise formed with a sinusoidal shape. (The seams in the illustrated metal layer are artifacts of the illustration software—though annealed metal pieces could of course be used.) Other shapes that create channels 611 when the layers are stacked can be envisioned. The illustrated shape favorably provides tight packing and for the use of uniform amounts of sealant

Sealant 612 confines reactants in the channel-area. The top row of channels 611, between the top two metal layers 620, are shaded. At the ends of the channels, the shaping of the metal layer can flatten or otherwise be appropriately shaped, creating a manifold for applying the reactants to the corresponding row of channels. Sealant 612 can be used to shape the plumbing of the manifolds, as described above.

In a given row of channels, sealing between the channels is typically not crucial. If needed, such internal sealing can be achieved, for example, by applying a thin layer of sealant to the metal layers, uniformly or at contact regions, and thereby providing internal sealant that seals as the sealant 612 is being sealed.

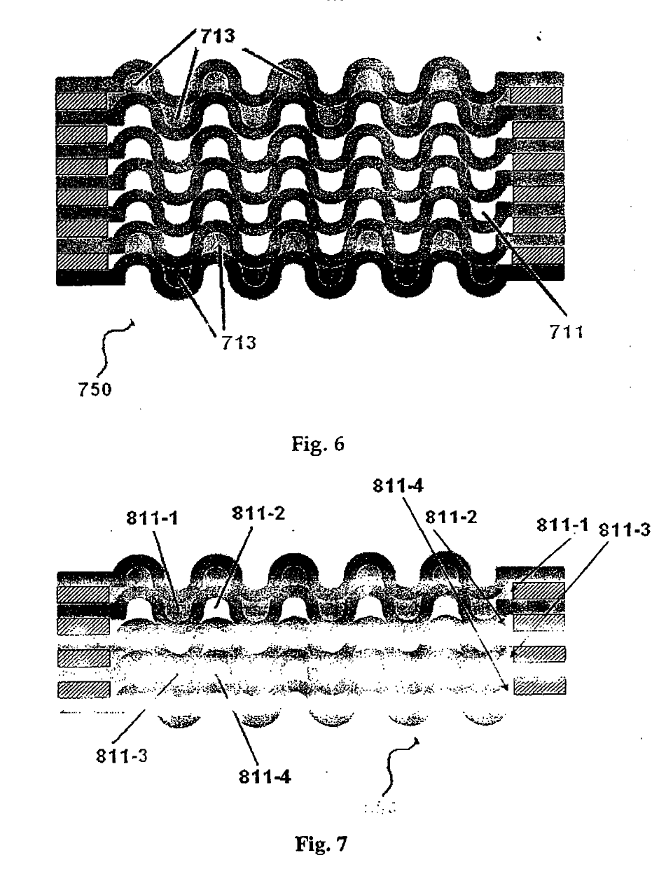

In another embodiment, reactor 750 (FIG. 6) incorporates channel rows that transport a heat exchange fluid. Shaded channels 713 transport a heat exchange fluid, such as a heated or cooled fluid, while channels 711 convey reactants and are typically coated with catalyst.

In another embodiment, reactor 850 (FIG. 7) incorporates channels 811-1 and 811-3 (shaded in drawing), occurring in alternating rows, for conducting one reaction, and channels 811-2 and 18114, occurring in the residual alternating rows, for conducting a second reaction.

The metal plates can be, for example, from 5 to 1,000 microns thick. In certain embodiments, the range of the plate thickness is from one of the following lower endpoints (inclusive) to one of the following upper endpoints (inclusive). The lower endpoints are 5, 10, 15, 20, 25, 30, 40, 50, 60, 70, 80, 90, 100, 150, 200, 250, 300, 400, 500, 600, 700, 800 and 900 microns (μm). The upper endpoints are 10, 15, 20, 25, 30, 40, 50, 60, 70, 80, 90, 100, 150, 200, 250, 300, 400, 500, 600, 700, 800, 900 and 1,000 microns. For example, the thickness can be from 10 to 100 microns.

Useful metals for the metal plates include, for example, stainless steel, titanium, Kovar, other alloys and the like, with the metal selected for stability in the reactor environment. The metal plates can also be coated (or cladded) with a second metal or ceramic for better thermal conductivity or chemical stability. The metal can in many instances be stainless steel.

Sealant/bonding material can favorably have a coefficient of expansion similar to that of the metal layers. Materials include plastic, ceramic (including glass ceramic), metal, and the like. For the method of manufacturing wherein the catalyst is applied prior to sealing, the sealing method should be one that utilizes a temperature (and time of temperature treatment) that is tolerated by the catalyst. One method, well suited for use with glass ceramic, is LTCC-M. Other methods include, for example, welding, hot pressing. The sealing is favorably at a temperature from 200° C. to 1,000° C. (e.g., from 50° C. to 1000° C. above the anticipated operating temperature of the highest temperature reaction for which the reactor is designed). In certain embodiments, the range of temperature for sealing is from one of the following lower endpoints (inclusive) to one of the following upper endpoints (inclusive). The lower endpoints are 200, 250, 300, 400, 500, 600, 700, 800 and 900° C. The upper endpoints are 250, 300, 400, 500, 600, 700, 800, 900 and 1,000° C.

In embodiments that corrugated metal, the separation gap between the metal plates (at the non-shaped boundaries) is, for example, 10 to 1,000 microns. In certain embodiments, the range of the thickness is from one of the following lower endpoints (inclusive) to one of the following upper endpoints (inclusive). The lower endpoints are 10, 15, 20, 25, 30, 40, 50, 60, 70, 80, 90, 100, 150, 200, 250, 300, 400, 500, 600, 700, 800 and 900 microns (μm). The upper endpoints are 15, 20, 25, 30, 40, 50, 60, 70, 80, 90, 100, 150, 200, 250, 300, 400, 500, 600, 700, 800, 900 and 1,000 microns. For example, the separation gap can be from 50 to 200 microns.

Catalysts can be selected based on the anticipated chemistry. Catalysts can be, for example, a precious metal, such as Pt, Pd, Ru, Rh, a non-precious metal, such as Ni, Co, Mn, Ti, Cr, V, or the alloys or compounds of the foregoing. Generally, a more controlled amount of catalyst will be applied to the channels if the application is done prior to enclosing the channels in the device. Coating methods include wash coating, Sol-gel, vacuum deposition, and the like. Coating methods such as wash coating can be applied after the device is put together.

A process for assembling a corrugated metal-containing reactor of the invention is:
1) Prepare thin metal plates and the sealant material (by tape casting, extrusion, or rolling).
2) Stamp the metal plates to corrugated shape at the center active area and manifold holes at perimeter.
3) Deposit the interface layer on the metal, if it is necessary, to enhance the bonding between metal plates and catalyst material.
4) Deposit the designated catalyst on the active area of the metal plates.
5) Punch the sealant material to desired size and shape with designated manifold holes.
6) Laminate the sealant material on the perimeter of metal plate.
7) Laminate several metal/sealant layers to build the multi-layer structure.
8) Fire the structure at high temperature to make the stacked reactor.

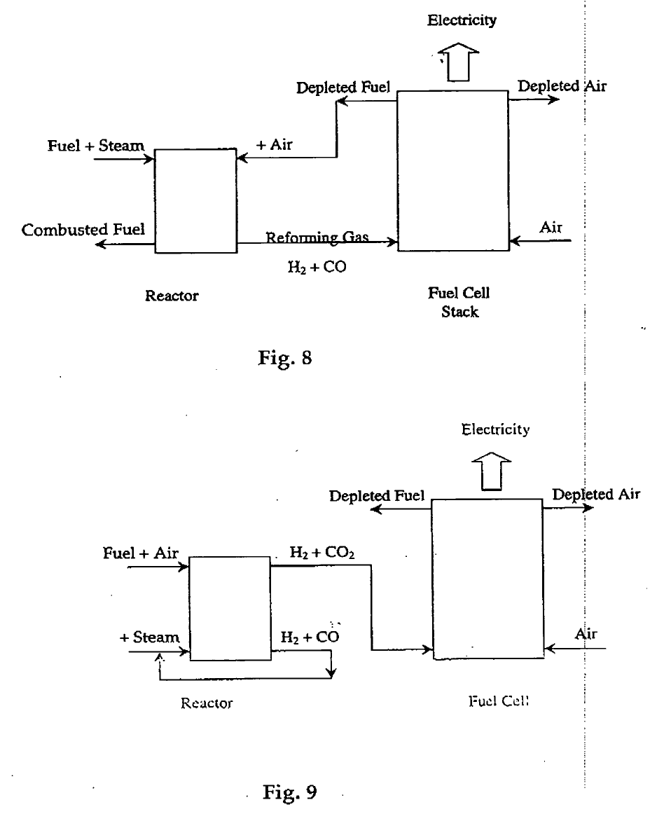

FIG. 8 illustrates a fuel cell system. Hydrocarbon fuels are mixed with steam, and reformed in the endothermic reaction layers of the microchannel reactor.
CH₄+H₂O+Heat→H₂+CO Eq. 1
The reforming gas is fed into the fuel cell to generate electricity. Then the depleted fuel is mixed with air and catalytically combusted in the exothermic reaction layers of the reactor.
H₂+O₂→H₂O+Heat Eq. 2
and CO+O₂→CO₂+Heat Eq. 3
The heat generated from these exothermic reactions (Eq. 2, 3) transport through metal plates between adjacent layers to support the endothermic reaction (Eq. 1) in the adjacent layers.

Another design to incorporate a reactor into a fuel cell system is shown in FIG. 9. Hydrocarbon fuels are mixed with air, and partially oxidized (POX) in exothermic reaction layers of the microchannel reactor.
CH₄+O₂→H₂+CO+Heat Eq. 4
The POX (mixture of H₂ and CO) is then mixed with steam and fed into endothermic reaction layers of the reactor to catalyze an endothermic shift reaction to obtain clean H₂ (without CO).
CO+H₂O+Heat→H₂+CO₂ Eq. 5

The clean H₂ is fed into fuel cell (such as a proton exchange membrane fuel cell, where clean H₂ is needed) to generate electricity. The heat generated in POX reaction (Eq. 4) transports through metal plates to adjacent shift reaction (Eq. 5) layers.

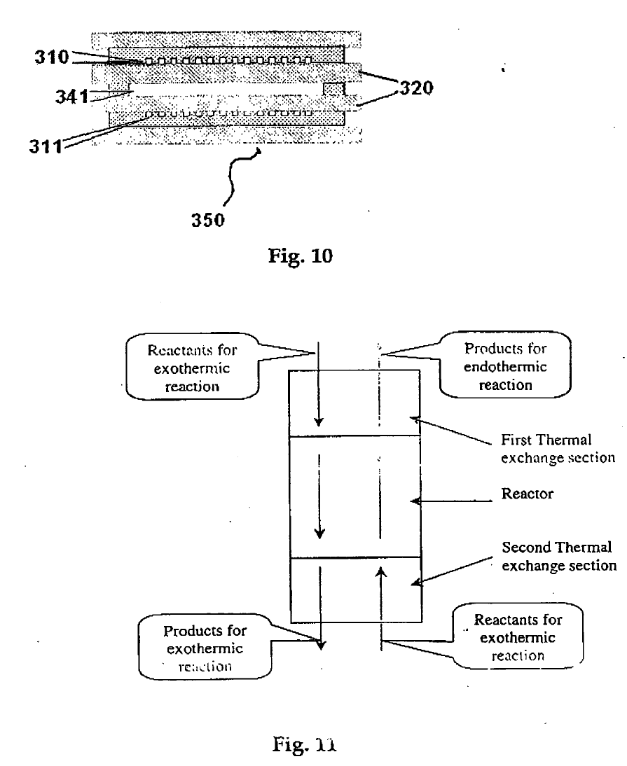

In another embodiment, reactor 350 has integrated heat exchange layers. As shown in FIG. 10, a heat exchange fluid such as hot or cooled fluid is fed into the heat exchange conduit 341. The heat is transport through metal layers 320 to adjacent fluid-handling layers 310 (which define channels 311).

In some embodiments, reactor is built with a preliminary heat exchanger such as a fluid pre-heater. As shown in FIG. 11, a reactant fluid for one reaction is fed to first heat exchanger, where it is cooled by the product of the second reaction. Similarly, a reactant fluid for the second reaction is fed to second heat exchanger, where it receives heat from the product of the first reaction.

In other embodiments, heating elements are incorporated to provide heat (or additional heat). For example, heating elements 442 can be incorporated between two fluid-handling sub-layers 410A and 410B, as illustrated in FIG. 12. Electrical conduits (not shown) to power the heating elements can be printed or otherwise applied to a surface of one of the sub-layers by methods known in the art. Appropriate heating elements include embedded metal wires, and printed Ag and Cu inks. Sensors, including sensors for gas or other reactants and thermal couples, can similarly be embedded in the ceramic layer.

Where a number in a given figure for a given embodiment is not individually described, that number corresponds to element(s) identified by the same last two digits for another embodiment. Hence, element 420 is a metal layer as in the first illustrated embodiment (for metal layer 20).

Definitions

The following terms shall have, for the purposes of this application, the respective meanings set forth below.

Not Significantly Degrade the Catalyst

A temperature, in conjunction with the time of its application, does not significantly degrade a catalyst if 80% of catalytic capacity remains.

Temperature

The temperature of a sealing operation is the temperature of an oven in which the sealing operation occurs. The individual structures of the device may or may not achieve this temperature during the sealing operation.

Publications and references, including but not limited to patents and patent applications, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A stacked reactor comprising:
three or more metal layers;
two or more catalyst layers sandwiched between the metal layers wherein:
(a) catalyst layers comprise catalyst-coated channels formed in a suitable material with depth and width dimensions independently from 10 to 2,000 microns, or
(b) surfaces of the metal layers are shaped so as to provide 40% or more surface area than would a flat surface; and
sealant enclosing the channel layers in a gas-Eight manner (which sealant may be contiguous with the material forming the catalyst-coated channels).

2. The stacked reactor of claim 1, wherein the sandwiched layers are according to (a).

3. The stacked reactor of claim 2, wherein in one or more catalyst layers the material thereof forms two sub-layers of catalyst-coated channels.

4. The stacked reactor of claim 2, wherein the suitable material is a ceramic material.

5. The stacked reactor of claim 2, wherein material at the ends of the channels forms manifolds for injecting gas into the channels or for collecting gas from the channels.

6. The stacked reactor of claim 2, wherein the catalyst-coated channels are sufficiently straight or smoothly curved so that gas flow is not obstructed.

7. The stacked reactor of claim 1, wherein the increased surface area is provided by a corrugated shape of stacked said metal layers.

8. The stacked reactor of claim 7, comprising ceramic interface layers coated on surfaces of the metal layers and supporting a catalyst coating

9. The stacked reactor of claim 1, wherein between one or more of the alternating metal layers is a heat exchange layer comprising channels of dimensions suitable for conveying a heat exchange fluid and sealant enclosing the heat exchange layers is a gas-tight manner.

10. A stacked reactor adapted to separately host a first and second reaction, one of which is exothermic and the other endothermic, the reactor comprising the reactor of claim 1 wherein one or more channel layers for conducting the first reaction are sandwiched, with intervening said metal layers, between two channel layers for conducting the second reaction, the stacked reactor comprising separate input and output conduits for the separate reactions.

11. The stacked reactor of claim 10, wherein catalyst for the endothermic reaction is selected to catalyze a hydrocarbon reformation reaction.

12. A fuel cell system comprising:
the stacked reactor of claim 11; and
connected to an output for the hydrocarbon reformation reaction, a fuel cell adapted to utilize the output for fuel.

13. The stacked reactor of claim 10, wherein catalyst for the exothermic reaction is selected to catalyze a hydrogen and carbon monoxide scrubbing reaction.

14. A fuel cell system comprising:
the stacked reactor of claim 13; and
connected to an output for the hydrocarbon reformation reaction, a fuel cell adapted to utilize the output for fuel, an exhaust of which fuel cell is connected to the portion of the stacked reactor with catalyst for hydrogen and carbon monoxide scrubbing.

15. A method of manufacturing a stacked reactor comprising:
providing sheets of shaped material, the shaping having fluid-handling structures adapted to provide channels having depth and width dimensions independently from 10 to 2,000 microns;
applying catalyst to the fluid-handling structures;
stacking the fluid-handling sheets and alternating metal sheets; and
sealing the periphery of the stack by annealing sealant at the periphery to the stacked metal sheets.

16. The method of claim 15, wherein the applying occurs prior to the sealing.

17. The method of claim 16, wherein the sealing occurs at a temperature of 1,000° C. or less, which temperature is selected to not significantly degrade the catalyst.

18. The method of claim 15, wherein the applying occurs after the sealing.

19. A method of manufacturing a stacked reactor comprising:
providing sheets of shaped metal, the shaping providing 40% or more surface area than would a flat surface;
applying catalyst to shaped surfaces of the metal sheets;
stacking the metal sheets; and
sealing the periphery of the stack by annealing sealant at the periphery to the stacked metal sheets.

20. The method of claim 20, further comprising, prior to the catalyst applying, applying ceramic interface layers to shaped surfaces of the metal sheets.
